(19) United States
(12) Patent Application Publication
(10) Pub. No.: US 2008/0052584 A1
(43) Pub. Date: Feb. 28, 2008

(54) Test apparatus and test method

(75) Inventor: Masaru Doi, Tokyo (JP)

Correspondence Address: OSHA LIANG L.L.P., 1221 MCKINNEY STREET, SUITE 2800, HOUSTON, TX, 77010, US

(73) Assignee: Advantest Corporation, Tokyo (JP)

(21) Appl. No.: 11/704,708

(22) Filed: Feb. 9, 2007

Related U.S. Application Data
(63) Continuation of application No. PCT/JP05/13643, filed on Jul. 26, 2005.

(30) Foreign Application Priority Data
Aug. 25, 2004 (JP) 2004-245883

(51) Int. Cl. G06F 11/277; G06F 11/25; G06F 11/263

(52) U.S. Cl. 714/736; 714/738; 714/744; 714/E11.155; 714/E11.175; 714/E11.177

(57) ABSTRACT

There is provided a test apparatus for testing a semiconductor device. The test apparatus includes a pattern generating section that sequentially reads and outputs waveform information to be used for testing the semiconductor device, where the waveform information is made up by a plurality, of pieces of data, a waveform generating section that generates a waveform based on the waveform information which is sequentially output from the pattern generating section, a match detecting section that detects, in response to a signal indicating a match detection request cycle output from the pattern generating section, whether an output signal output from the semiconductor device matches an expected value pattern, and an interrupt section that, when the match detecting section detects that the output signal matches the expected value pattern, terminates the match detection request cycle and causes the pattern generating section to output next waveform information.

### CROSS REFERENCE TO RELATED APPLICATION

This is a continuation application of PCT/JP2005/013643 filed on Jul. 26, 2005 which claims priority from a Japanese Patent Application(s) No. 2004-245883 filed on Aug. 25, 2004, the contents of which are incorporated herein by reference.

### BACKGROUND

1. Technical Field

The present invention relates to a test apparatus and a test method for testing a semiconductor device. More particularly, the present invention relates to a test apparatus that outputs a signal obtained as a result of pipeline processing.

2. Related Art

Testing a device such as a flash memory includes testing the function and performance of the device under test (DUT) in terms of multiple aspects. When the DUT is tested in terms of multiple aspects, data erase and writing is repeatedly performed. A test apparatus judges whether each data erase or writing operation is normally performed, and the result of the judgment determines a test pattern to be subsequently performed. Here, a conventional test apparatus makes the judgment by means of a so-called match detecting function. With the match detecting function, the test apparatus judges whether the signal output from the DUT as a result of the data erase or writing matches an expected value.

When data is written into a predetermined address in the DUT, the test apparatus inputs into the DUT a command, data and the like which are required to perform the data writing. When the DUT is a flash memory, for example, each DUT has different characteristics relating to charge injection into a floating gate. Accordingly, each DUT has a different time period from when data is input to when the data is written into a memory cell. Here, the flash memory executes therein an automatic writing sequence which is referred to as polling. For the above-mentioned reasons, each DUT has a different time period for the data writing performed by the polling. When the data writing is normally completed, the DUT outputs predetermined data. While the DUT is executing the polling, the test apparatus can not write data into the next address. Therefore, while repeatedly performing the match detecting operation until the data output from the DUT matches the expected value, the test apparatus is required to keep on hold the data writing into the next address. On detection of the match, the test apparatus determines a test pattern to be subsequently performed, and is allowed to proceed to perform a sequence of writing data into the next address.

The test apparatus performs the match detecting operation by comparing the data output from the DUT with the expected value once in each match detection cycle of a predetermined time period. The test apparatus repeats the match detection cycle, to detect the completion of the polling. When the match detection cycle in which the polling completion is detected ends, the test apparatus performs a next test pattern.

Here, since the conventional test apparatus performs a match detecting operation only once in each match detection cycle as mentioned above, there is a loss time. Which is to say, the conventional test apparatus is inefficient in terms of match detection. The efficiency of match detection can be raised in such a manner that the cycle time of the match detection cycle is sufficiently decreased and the number of repeatedly-performed match detection cycles is sufficiently increased. However, the cycle time of the match detection cycle for the test apparatus has a lower limit. Accordingly, the conventional test apparatus can not perform match detection with the match detection cycle time being set to a sufficiently short time period, and therefore has difficulties in improving the efficiency of match detection.

Here, the result of the match detection determines a test pattern to be subsequently performed. However, in a test apparatus that outputs a signal obtained as a result of pipeline processing, a signal requesting match detection is transmitted to a match detecting circuit via cascaded flip-flops, and a signal indicating that no match is detected is transmitted back via the cascaded flip-flops. For these reasons, the test apparatus that outputs a signal obtained as a result of pipeline processing has difficulties in raising the efficiency of match detection.

In view of the above, an advantage of some embodiments of the present invention is to provide a test apparatus and a test method which can solve the above-described problem. This object is achieved by combining the features recited in the independent claims. The dependent claims define further effective specific example of the present invention.

### SUMMARY

To solve the above-described problem, a first embodiment of the present invention provides a test apparatus for testing a semiconductor device. The test apparatus includes a pattern generating section that sequentially reads and outputs waveform information to be used for testing the semiconductor device, where the waveform information is made up by a plurality of pieces of data, a waveform generating section that generates a waveform based on the waveform information which is sequentially output from the pattern generating section, a match detecting section that detects, in response to a signal indicating a match detection request cycle output from the pattern generating section, whether an output signal output from the semiconductor device matches an expected value pattern output from the pattern generating section, and an interrupt section that, when the match detecting section detects that the output signal matches the expected value pattern, terminates the match detection request cycle and causes the pattern generating section to output next waveform information.

The pattern generating section includes a period generating section that generates a predetermined period signal, and a plurality of flip-flops cascaded that (i) sequentially store thereon the plurality of pieces of data making up the waveform information and (ii) output the sequentially stored plurality of pieces of data to the waveform generating section in synchronization with the period signal generated by the pattern generating section. When the match detecting section detects that the output signal from the semiconductor device matches the expected value pattern, the interrupt section may cause the period generating section to generate a next period signal prior to an original end timing of the match detection request cycle. The plurality of flip-flops may store thereon in advance a plurality of pieces of data making up waveform information which is subsequently output when the match detecting section detects that the output signal matches the expected value pattern, and the number of the plurality of pieces of data may be determined in accordance with the number of stages of the plurality of flip-flops.

The interrupt section may include a no match control section that, when the match detecting section detects no match between the output signal and the expected value pattern within the match detection request cycle, causes the period generating section to output a period signal having pulses the number of which is determined in accordance with the number of the stages of the plurality of flip-flops, prior to the original end timing of the match detection request cycle, and a period holding section that suspends the output of the plurality of pieces of data making up the waveform information from the plurality of flip-flops to the waveform generating section for an interval during which the no match control section causes the period generating section to output the period signal having the pulses the number of which is determined in accordance with the number of the stages of the plurality of flip-flops.

The interrupt section may further include a match control section that, when the match detecting section detects that the output signal matches the expected value pattern, outputs a match signal having substantially the same pulse width as the period signal, and the period generating section may output, as the period signal, a signal obtained by performing a logic addition on the period signal which is generated whenever a cycle time predetermined for waveform information elapses and the match signal.

The period generating section may include a period counter that receives period data indicating a cycle time associated with the waveform information in response to an enable signal supplied thereto, measures a time period by counting a reference clock supplied thereto, and outputs the period signal when the measured time period becomes equal to the cycle time indicated by the period data, and a logical OR circuit that outputs, as the period signal, a signal obtained by performing a logical addition on the period signal output from the period counter and the match signal, and inputs the period signal into the period counter as the enable signal.

The no match control section may output a no match signal to the period holding section when the match detecting section detects no match between the output signal and the expected value pattern within the match detection request cycle, and, when receiving the no match signal, the period holding section (i) may prohibit the period counter from counting the reference clock for the interval during which the period generating section outputs the period signal having the pulses the number of which is determined in accordance with the number of the stages of the plurality of flip-flops, and (ii) may output the period signal to the logical OR circuit after the period generating section completes outputting the period signal having the pulses the number of which is determined in accordance with the number of the stages of the plurality of flip-flops.

The waveform generating section may include a strobe generating section that generates a plurality of strobe signals having different phases from each other within the match detection request cycle, and a timing comparator that detects a value of the output signal at each of a plurality of timings defined by the plurality of strobe signals, and the match detecting section may detect whether the value of the output signal detected by the timing comparator matches the expected value pattern supplied thereto.

The strobe generating section preferably does not generate the plurality of strobe signals after a predetermined end timing within the match detection request cycle. Also, the strobe generating section preferably does not generate the plurality of strobe signals before a predetermined start timing within the match detection request cycle.

A second embodiment of the present invention provides a test method for testing a semiconductor device. The test method includes sequentially reading and outputting waveform information to be used for testing the semiconductor device, where the waveform information is made up by a plurality of pieces of data, generating a waveform based on the waveform information which is sequentially output in the sequential reading and outputting, detecting, in response to a signal indicating a match detection request cycle output in the sequential reading and outputting, whether an output signal output from the semiconductor device matches an expected value pattern output in the sequential reading and outputting, and terminating the match detection request cycle and outputting next waveform information in the sequential reading and outputting, when the output signal matches the expected value pattern.

Here, all the necessary features of the present invention are not listed in the summary. The sub-combinations of the features may become the invention.

### BRIEF DESCRIPTION OF THE DRAWINGS

FIG. 1 shows one example of the configuration of a test apparatus 100 relating to an embodiment of the present invention.

FIG. 2 shows one example of the configuration of a pattern generating apparatus 10.

FIG. 3 shows, as one example, the configuration of a test unit 60 and the configuration of a pin electronics 160.

FIG. 4 is a timing chart showing, as one example, a signal output from a logical AND circuit 110 and a signal output from a no match control section 48, which are output when a match is successfully detected within a match detection request cycle.

FIG. 5 is a timing chair showing, as one example, a signal output from the logical AND circuit 110 and a signal output from the no match control section 48, which are output when no match is detected within the match detection request cycle.

FIG. 6 is a flow chair showing one example of a test method relating to an embodiment of the present invention.

### DESCRIPTION OF EXEMPLARY EMBODIMENTS

Hereinafter, one aspect of the present invention will be described through some embodiments of the present invention. The embodiments do not limit the invention according to the claims, and all the combinations of the features described in the embodiments are not necessarily essential to means provided by aspects of the invention.

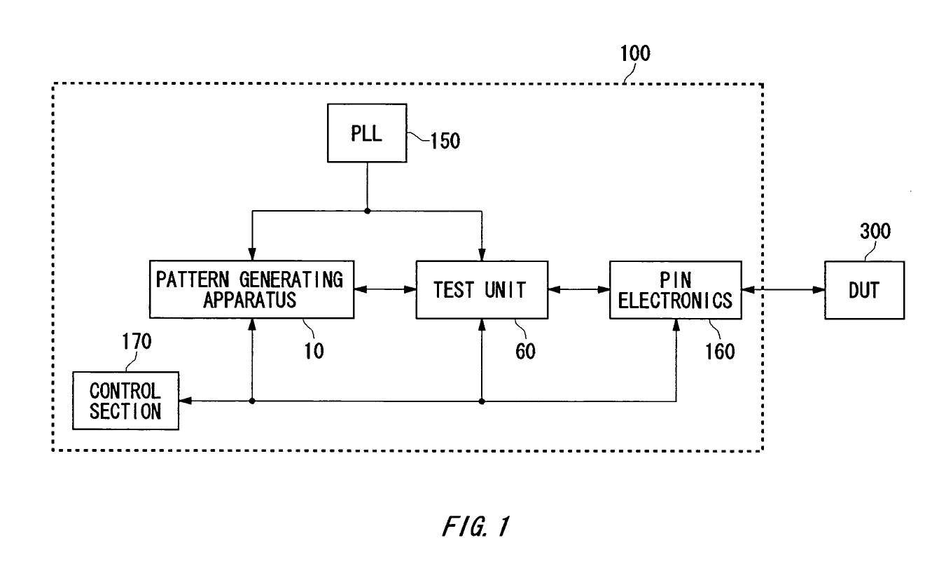

FIG. 1 shows one example of the configuration of a test apparatus 100 relating to an embodiment of the present invention. The test apparatus 100 tests a semiconductor device 300 such as a flash memory. The test apparatus 100 includes therein a pattern generating apparatus 10, a test unit 60, a PLL 150, a pin electronics 160, and a control section 170.

The control section 170 controls the pattern generating apparatus 10, test unit 60 and pin electronics 160, so that the test apparatus 100 tests the semiconductor device 300. For example, the control section 170 supplies a test program used to test the semiconductor device 300 to the pattern generating apparatus 10 in advance, to cause the pattern generating apparatus 10 to generate a test pattern and the like based on the test program.

The PLL 150 generates a reference clock having a predetermined cycle tune, and supplies the generated reference clock to the pattern generating apparatus 10 and test unit 60. The pattern generating apparatus 10 operates in accordance with the reference clock. The pattern generating apparatus 10 sequentially reads waveform information indicating, for example, a pattern to be used to test the semiconductor device 300 and outputs the read waveform information to the test unit 60.

The test unit 60 is shown as one example of a waveform generating section and a match detecting section relating to the present invention. The test unit 60 operates in accordance with the reference clock. The test unit 60 receives a period signal and the waveform information from the pattern generating apparatus 10, and inputs a waveform into the semiconductor device 300 via the pin electronics 160. Furthermore, the test unit 60 detects whether a signal output from the semiconductor device 300 matches an expected value pattern supplied from the pattern generating apparatus 10, in response to a match detection request cycle signal supplied from the pattern generating apparatus 10.

The pin electronics 160 is a circuit to transfer signals between the test unit 60 and semiconductor device 300. For example, the pin electronics 160 includes therein a driver and a comparator in correspondence with each pin of the semiconductor device 300.

When the output signal output from the semiconductor device 300 matches the expected value pattern, the pattern generating apparatus 10 terminates a match detection request cycle, and causes the test unit 60 to generate a next waveform. Controlled in the above-described manner, the test apparatus 100 can reduce the loss time in relation to match detection, to accomplish efficient testing of a semiconductor device.

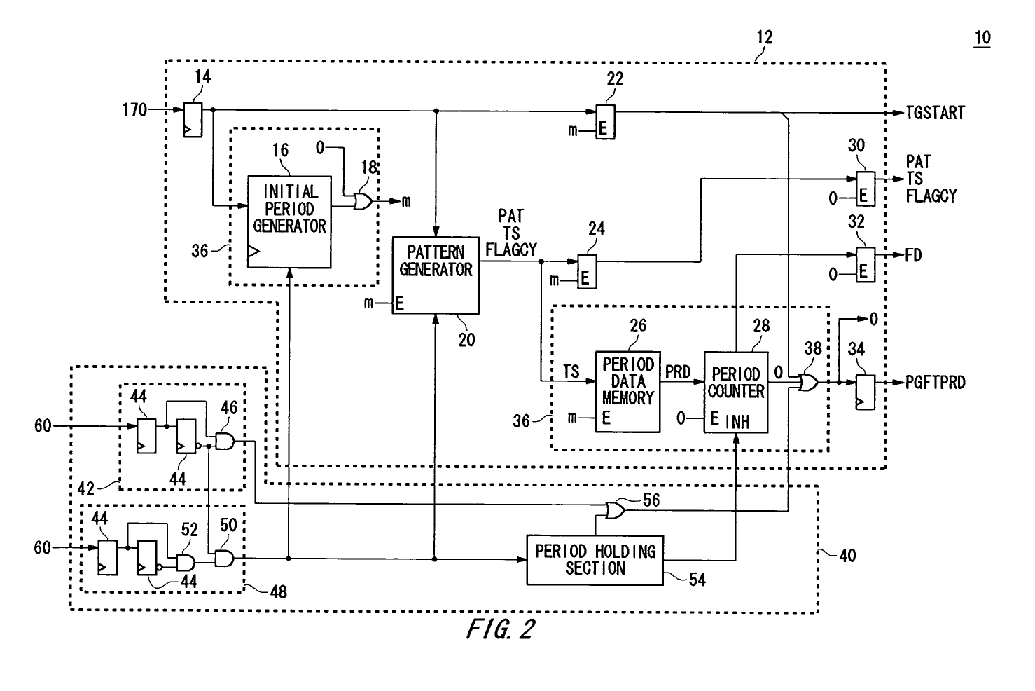

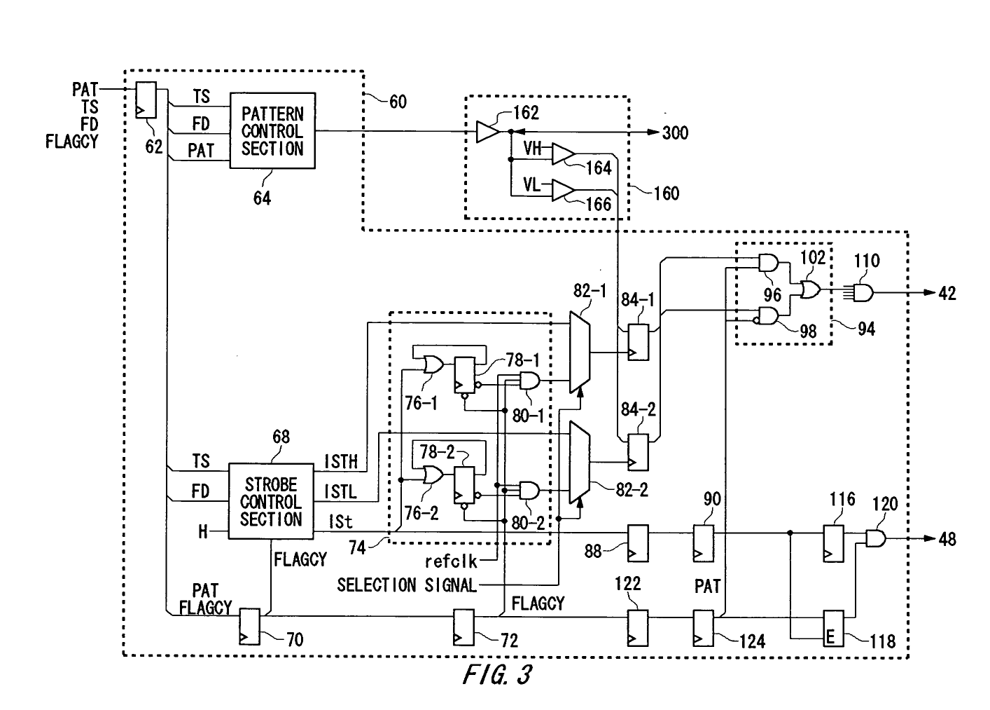

FIG. 2 shows one example of the configuration of the pattern generating apparatus 10. The pattern generating apparatus 10 includes therein a pattern generating section 12 and an interrupt section 40. The pattern generating section 12 is a circuit to sequentially read and output waveform information used to test the semiconductor device 300. The pattern generating section 12 includes therein a period generating section 36, a plurality of flip-flops 14, 22, 24, 30, 32 and 34 and a pattern generator 20. Here, note that each flip-flop shown in FIGS. 2 and 3 may be shown as including only a flip-flop of one stage, but may be constituted by a plurality of flip-flops cascaded. In particular, each of the flip-flops 22 and 24 may achieve pipeline processing in which data is shifted from a certain stage to the immediately following stage in accordance with a period signal 177.

The flip-flop 14 is supplied a start signal to start an operation from the control section 170. The flip-flop 14 is constituted by a plurality of flip-flops cascaded to be capable of outputting the start signal in synchronization with the reference clock. The output start signal is supplied to an initial period generator 16 of the period generating section 36, the pattern generator 20 and the flip-flop 22, to cause the initial period generator 16 and pattern generator 20 to operate.

The pattern generator 20 generates, based on the test program supplied thereto in advance from the control section 170, a test pattern to be supplied to the semiconductor device 300 (PAT), a match detection request signal to request the test unit 60 to perform match detection (FLAGCY) and a timing setting signal defining a cycle time and a timing clock for each piece of waveform information (TS), and sequentially outputs the generated signals. Here, the match detection request signal FLAGCY indicates a match detection cycle. For example, the match detection request signal FLAGCY indicates an H logic during a match detection cycle. The signals output from the pattern generator 20 are sequentially stored on the flip-flop 24.

The period generating section 36 includes therein a period data memory 26, a period counter 28, a logical OR circuit 38, the initial period generator 16, and a logical OR circuit 18. The period generating section 36 generates, based on the timing setting signal generated by the pattern generator 20, a period signal 0 defining a start timing of the cycle time of the waveform information associated with the timing setting signal. In other words, the period generating section 36 generates and outputs the period signal 0 indicating a test cycle in accordance with predetermined setting of a test cycle time. Also, the period generating section 36 generates and outputs the period signal an to replace the signals stored on the flip-flop 24, depending on the result of the match detection performed by the test unit 60.

The period data memory 26 stores thereon in advance pieces of period data (PRD) in association with timing setting signals, and outputs period data associated with the timing setting signal output from the pattern generator 20.

When supplied each enable signal, the period counter 28 receives the period data output from the period data memory 26, measures a time period by counting the reference clock supplied thereto (not shown), and outputs the period signal 0 when the measured time period becomes equal to the cycle time indicated by the period data. The reference sign FD in FIG. 2 indicates part of period data which represents a time period less than the resolution of the reference clock. The period signal 0 is input, as the enable signal, into the period counter 28, flip-flop 30, and flip-flop 32. The flip-flops 30 and 32 output the signals PAT, TS, FLAGCY, and FD to the test unit 60 in synchronization with the period signal 0.

Operating in the above-described manner, the pattern generating section 12 outputs the test pattern to the test unit 60 at the start timing of each test cycle. The period signal 0 is input into the test unit 60 as the enable signal (PGFTPRD) via the flip-flop 34. Operating in this manner, the pattern generating section 12 causes the test unit 60 to operate in accordance with the test cycle.

Note that a test cycle to be executed after the match detection request cycle is determined by the result of the match detection. Here, the pattern generator 20 sequentially stores in advance, on the flip-flop 24, waveform information associated with a test cycle which is to be executed subsequently when match is successfully detected. When receiving a no match signal which is output from the interrupt section 40 and indicates that no match is detected, the initial period generator 16 outputs a period signal having pulses the number of which is determined in accordance with the number of the stages in the flip-flop 24. The logical OR circuit 18 outputs a logical OR between this period signal and the period signal 0, as the period signal m.

The period signal m is input, as the enable signal, into the flip-flop 22, flip-flop 24, flip-flop 26, and the pattern generator 20. The pattern generator 20 sequentially generates a pattern to be executed subsequently when no match is detected, in accordance with the period signal m, and sequentially stores the generated pattern onto the flip-flop 24. In a conventional test apparatus, the flip-flop 24 stores thereon in advance a pattern to be generated subsequently when no match is detected. Therefore, if match is successfully detected, the pattern having been stored on the flip-flop 24 needs to be replaced with a new pattern. On the other hand, the test apparatus 100 relating to the present embodiment simply executes the pattern which is stored in advance on the flip-flop 24 when match is successfully detected. When no match is detected, the test apparatus 100 relating to the present embodiment simply judges the semiconductor device 300 to be defective, and performs a necessary process. In this way, the test apparatus 100 relating to the present embodiment can realize a shorter time period for testing.

The flip-flop 22 has therein the same number of flip-flops as the flip-flop 24. The flip-flop 22 synchronizes the start signal with the signal output from the flip-flop 24. The start signal output from the flip-flop 22 is input into the logical OR circuit 38 and test unit 60, to cause the period generating section 36 and test unit 60 to operate.

When the test unit 60 judges that the output signal output from the semiconductor device 300 matches the expected value pattern, that is to say, when match is successfully detected in the test unit 60, the interrupt section 40 terminates the match detection request cycle, and causes the test unit 60 to execute the next pattern. The interrupt section 40 includes therein a match control section 42, a no match control section 48, a period holding section 54, and a logical OR circuit 56.

When the test unit 60 successfully detects match, the match control section 42 receives a match signal and outputs the match signal in synchronization with the reference clock. The match control section 42 includes therein flip-flops 44 and a logical AND circuit 46. In FIG. 2, the match control section 42 includes therein the flip-flops 44 of two stages. However, it should be noted here that the flip-flop 44 of the first stage shown in FIG. 2 has therein a plurality of flip-flops cascaded to achieve synchronization with the reference clock. The logical AND circuit 46 outputs a logical AND between the match signal output from the flip-flop 44 of the first stage shown in FIG. 2 and the inverted signal of the match signal, which is output from the flip-flop 44 of the next stage. Operating in this maimer, the match control section 42 outputs the match signal having substantially the same pulse width as the period signal.

The match signal output from the match control section 42 is input into the logical OR circuit 38 via the logical OR circuit 56. The logical OR circuit 38 outputs, as the period signal 0, a logical OR between the period signal 0 output from the period counter 28 and the match signal. To put it differently, the interrupt section 40 inserts the match signal into the period signal 0, so as to cause the period generating section 36 to output the period signal 0 in accordance with the match signal and thus cause a new test cycle to be started, prior to the original end timing of the match detection request cycle.

In this case, the logical OR circuit 38 inputs the period signal 0 into the flip-flops 30 and 32 as the enable signal, and inputs a new pattern and the like into the test unit 60. The logical OR circuit 38 also inputs the period signal 0 into the period counter 28 as the enable signal. In accordance with the period signal 0, the period counter 28 reads period data associated with the new test cycle, and controls the new test cycle. With the above-described operation, when successfully detecting match, the test apparatus 100 can newly generate a test cycle prior to the original end timing of the match detection request cycle, thereby achieving more efficient testing.

When no match is detected between the output signal output from the semiconductor device 300 and the expected value pattern within the match detection request cycle, the no match control section 48 outputs a no match signal in synchronization with the reference clock. The no match control section 48 includes therein a logical AND circuit 50 in addition to the same constituents as the match control section 42. How the no match control section 48 operates is described later with reference to FIG. 3).

The no match signal output from the no match control section 48 is input into the initial period generator 16 as mentioned above, so that the period signal m is generated to store a new pattern into the flip-flop 24. Which is to say, when the test unit 60 detects no match within the match detection request cycle, the no match control section 48 causes the initial period generator 16 to output a period signal having pulses the number of which is determined in accordance with the number of the stages of the flip-flops 24 prior to the original end timing of the match detection cycle.

When receiving the no match signal, the period holding section 54 prohibits the period counter 28 from counting the reference clock while the initial period generator 16 outputs the period signal having the predetermined number of pulses. When the initial period generator 16 completes outputting the period signal having the predetermined number of pulses, the period holding section 54 outputs a match signal to the logical OR circuit 38 via the logical OR circuit 56. Operating in the above-described manner, the test apparatus 100 can stop the pattern output from the flip-flop 24 while the pattern to be generated when no match is detected is being stored onto the flip-flop 24. In this manner, the test apparatus 100 can prevent malfunction.

FIG. 3 shows, as one example, the configuration of the test unit 60 and the configuration of the pin electronics 160. The test unit 60 includes therein a pattern control section 64, a strobe control section 68, a strobe generating section 74, a match detecting section 94, selecting sections 82-1 and 82-2 (hereinafter collectively referred to as a selecting section 82), flip-flops 62, 70, 72, 84,88, 90, 116, 118 and 124, and logical AND circuits 110 and 120. The pin electronics 160 includes therein a driver 162 and comparators 164 and 166.

The reset terminal of each of the flip-flops provided in the test unit 60 is input with the start signal (TGSTART) output from the pattern generating section 12. The pattern control section 64, strobe control section 68, and flip-flops 62 and 70 are input with the period signal 0 output from the pattern generating section 12, as the enable signal (PGFTPRD), and operate in synchronization with the period signal 0.

The pattern control section 64 receives the ting setting signal (TS), highly accurate period data (FD) and test pattern (PAT) via the flip-flop 62. Based on these received signals, the pattern control section 64 outputs a test signal to be input into the semiconductor device 300. For example, the test pattern may be a digital pattern formed by arranging the numbers “0” and “1”. The pattern control section 64 generates the test signal indicating the voltage value determined by the test pattern at cycles determined by the timing setting signal, and inputs the generated test signal into the driver 162 at a timing determined in accordance with the timing signal.

The strobe control section 68 receives the timing setting signal and timing signal via the flip-flop 62, and also receives a signal indicating an H logic, for example, from the control section 170. The strobe control section 68 outputs a reference strobe signal (IST) having one pulse at a predetermined timing during the match detection request cycle. The flip-flop 70 outputs the test pattern and match detection request cycle signal in synchronization with the pattern control section 64 and strobe control section 68.

The comparator 164 is a level comparator to compare the voltage value of the output signal output from the semiconductor device 300 with a predetermined high voltage value VH, and outputs a signal based on the result of the comparison. In the present embodiment, the comparator 164 outputs an H level comparison signal indicating “1” when the voltage value of the output signal is equal to or higher than the voltage value VH and indicating “0” when the voltage value of the output signal is equal to or lower than the voltage value VH. The comparator 166 is a level comparator to compare the voltage value of the output signal output from the semiconductor device 300 with a predetermined low voltage value VL, and outputs an L level comparison signal based on the result of the comparison.

The strobe generating section 74 generates a plurality of strobe signals which have different phases from each other during the match detection request cycle. For example, the strobe generating section 74 outputs the reference clock output from the PLL 150 as the strobe signals during the match detection request cycle.

The strobe generating section 74 includes therein logical OR circuits 76-1 and 76-2 (hereinafter collectively referred to as a logical OR circuit 76), flip-flops 78-1 and 78-2 (hereinafter collectively referred to as a flip-flop 78) and logical AND circuits 80-1 and 80-2 (hereinafter collectively referred to as a logical AND circuit 80). The strobe generating section 74 is input with the signal indicating the match detection request cycle (FLAGCY) via the flip-flop 72.

The logical OR circuit 76 inputs, into the flip-flop 78, a logical OR between the reference strobe signal output from the strobe control section 68 and the signal output from the flip-flop 78. The inverted output of the flip-flop 78 is fixed to an L logic from when the strobe control section 68 outputs the reference strobe signal to when the flip-flop 78 is reset.

The reset terminal of the flip-flop 78 is input with the signal indicating the match detection request cycle (FLAGCY), and the flip-flop 78 is reset when the signal (FLAGCY) switches to an L logic. In this way, the value of the flip-flop 78 can be reset for each match detection request cycle.

The logical AND circuit 80 outputs a logical AND between the reference clock, the inverted output of the flip-flop 78 and the signal indicating the match detection request cycle (FLAGCY). Which is to say, the reference strobe signal output from the strobe control section 68 defines the end timing of the period during which the strobe generating section 74 outputs the plurality of strobe signals, and the logical AND circuit 80 outputs the reference clock as the strobe signals from the start timing of the match detection request cycle which is defined by the signal FLAGCY to when the strobe control section 68 outputs tie reference strobe signal. The match detecting section 94 detects whether the level comparison signals output from the comparators 164 and 166 match the expected value, at timings determined in accordance with the strobe signals.

The strobe control section 68 may generate an H level reference strobe signal defining the end timing of a period during which strobe signals corresponding to the H level comparison signal are generated and an L level reference strobe signal defining the end timing of a period during which strobe signals corresponding to the L level comparison signal are generated. The H level reference strobe signal is input into the logical OR circuit 76-1, and the logical AND circuit 80-1 outputs the strobe signals corresponding to the H level comparison signal. The L level reference strobe signal is input into the logical OR circuit 76-2, and the logical AND circuit 80-2 outputs the strobe signals corresponding to the L level comparison signal. As described above, the test apparatus 100 relating to the present embodiment can freely set the start and end timings for match detection within the match detection cycle. Specifically speaking, by appropriately setting the timing of the reference strobe signal generated by the strobe control section 68, the test apparatus 100 relating to the present embodiment can easily set the start and end timings for match detection. The desired specifications for the test apparatus 100 are different depending on the use of the semiconductor device to be tested. According to the present embodiment, the match detection period can be easily adjusted in accordance with the desired specifications.

The strobe control section 68 may further output a reference strobe signal defining, within the match detection request cycle, the start timing of the period during which the strobe generating section 74 outputs the strobe signals. In this case, the strobe generating section 74 may not generate the strobe signals after the end timing defined by the reference strobe signal and before the start timing defined by another reference strobe signal, within the match detection request cycle.

The selecting section 82-1 selects a strobe signal output from the strobe control section 68 when the signal FLAGCY indicates the L level, and selects the strobe signals output from the logical AND circuit 80-1 when the signal FLAGCY indicates the H level. In this way, within the match detection request cycle, match detection is performed based on the plurality of strobe signals mentioned above. On the other hand, outside the match detection request cycle, timing comparison is performed based on the normal strobe signal output from the strobe control section 68.

Similarly to the selecting section 82-1, the selecting section 82-2 selects a strobe signal output from the strobe control section 68 when the signal FLAGCY indicates the L level, and selects the strobe signals output from the logical AND circuit 80-2 when the signal FLAGCY indicates the H level.

The flip-flop 84 is shown as one example of a timing comparator relating to the present invention. The flip-flop 84-1 detects the value of the H level comparison signal at the timings determined by the strobe signals output from the logical AND circuit 80-1. The flip-flop 84-2 detects the value of the L level comparison signal at the timings determined by the strobe signals output from the logical AND circuit 80-2.

The match detecting section 94 detects whether the values detected by the flip-flop 84 match the expected value supplied thereto. The match detecting section 94 is supplied with the test pattern transmitted via the flip-flops 70, 72, 122 and 124, as the expected value pattern. The flip-flop 122 operates in synchronization with the flip-flop 84, and the flip-flop 124 operates in synchronization with the flip-flop 90.

The match detecting section 94 includes therein logical AND circuits 96 and 98 and a logical OR circuit 102. The logical AND circuit 96 outputs a logical AND between each of the values sequentially detected at the plurality of timings by the flip-flop 84-1 and the expected value pattern. To put it differently, the logical AND circuit 96 outputs a signal indicating an H logic when both the H level comparison signal and expected value pattern indicate an H logic. The logical AND circuit 98 outputs a logical AND between each of the values sequentially detected at the plurality of timings by the flip-flop 84-2 and the inverted signal of the expected value pattern. To put it differently, the logical AND circuit 98 outputs a signal indicating an H logic when the L level comparison signal indicates the 14 logic and the expected value pattern indicates an L logic. The logical OR circuit 102 outputs a logical OR between the signals output from the logical AND circuits 96 and 98. To put it differently, the logical OR circuit 102 outputs a match signal when one of the output signals from the logical AND circuits 96 and 98 indicates an H logic.

The logical AND circuit 110 outputs a logical AND between the match signals corresponding to the respective pins of the semiconductor device 300. In other words, the logical AND circuit 110 outputs the match signal when match is successfully detected for all the pins of the semiconductor device 300 which is to be tested. The logical AND circuit 110 may output a logical AND between match signals associated with a plurality of semiconductor devices 300.

The flip-flop 88 outputs the reference strobe signal in synchronization with the flip-flop 84. The flip-flops 90 and 116 each output the reference strobe signal received from the flip-flop 88 at a predetermined timing. The flip-flops 122, 124 and 118 receive the reference strobe signal as the enable signal. The flip-flop 118 outputs the match detection request signal (FLAGCY) in synchronization with the flip-flop 116.

The logical AND circuit 120 outputs a logical AND between the signals output from the flip-flops 116 and 118. In other words, the logical AND circuit 120 outputs the reference strobe signal generated by the strobe control section 68, within the match detection request cycle. The signal output from the logical AND circuit 120 is input into the no match control section 48. Which is to say, the logical AND circuit 120 outputs the reference strobe signal irrespective of whether match is successfully detected within the match detection request cycle.

Similarly to the logical AND circuit 46 of the match control section 42, the logical AND circuit 52 of the no match control section 48 generates a signal having substantially the same pulse width as the period signal, based on the reference strobe signal. The logical AND circuit 50 outputs a logical AND between the inverted signal of the match signal and the output signal from the logical AND circuit 52. To put it differently, the logical AND circuit 50 outputs, as the no match signal, the above-mentioned signal having substantially the same pulse width as the period signal, when no match is detected prior to the timing of the reference strobe signal during the match detection request cycle.

As described above, the test apparatus 100 relating to the present embodiment can perform match detection at a plurality of timings within the match detection request cycle, by using the reference clock as the strobe signals. The test apparatus 100 terminates the match detection request cycle when successfully detecting match, and subsequently generates a test cycle. Consequently, the test apparatus 100 relating to the present embodiment can achieve more efficient testing.

The conventional test apparatus repeatedly generates the match detection request cycle when performing match detection. Accordingly, the flip-flop 24 or the like stores thereon a pattern to be used when no match is detected. Therefore, the conventional test apparatus is required to replace the pattern having been stored on the flip-flop 24 or the like when match is successfully detected. On the other hand, the test apparatus 100 relating to the present embodiment assigns a sufficiently long time period for the match detection request cycle, and performs match detection at a plurality of timings within the cycle. In this way, the test apparatus 100 does not need to repeat the match detection request cycle. Therefore, the flip-flop 24 or the like can store thereon in advance a pattern to be used when match is successfully detected. Also, the test apparatus 100 is not required to store again the pattern for match detection. As a result, the test apparatus 100 relating to the present embodiment can realize more efficient testing.

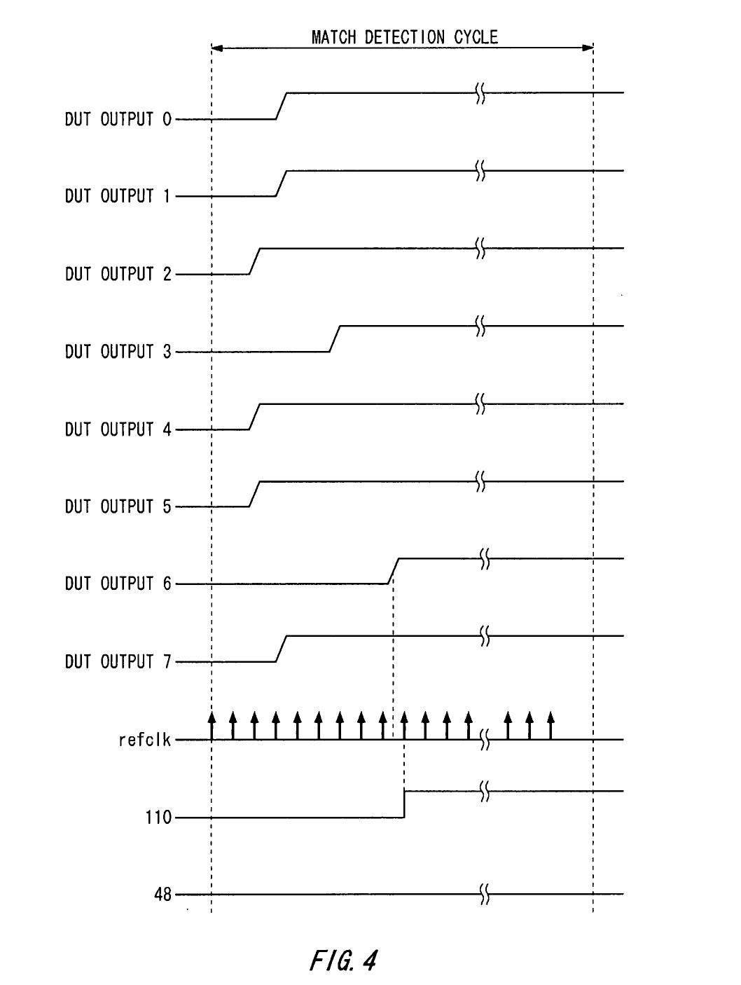

FIG. 4 is a timing chart illustrating, as one example, the signals which are output from the logical AND circuit 110 and no match control section 48 when match is successfully detected within the match detection request cycle. In the present embodiment, the test apparatus 100 performs match detection on the signals output from the output pins 0-7 of the semiconductor device 300.

As shown in FIG. 4, the match detecting section 94 performs match detection on each of the output signals based on the reference clocks from the start timing of the match detection request cycle to a predetermined end timing. When match is successfully detected for all the output signals, the logical AND circuit 110 outputs a signal indicating an H logic. Meanwhile, when match is successfully detected for all the output signals, the no match control section 48 outputs a signal indicating an L logic.

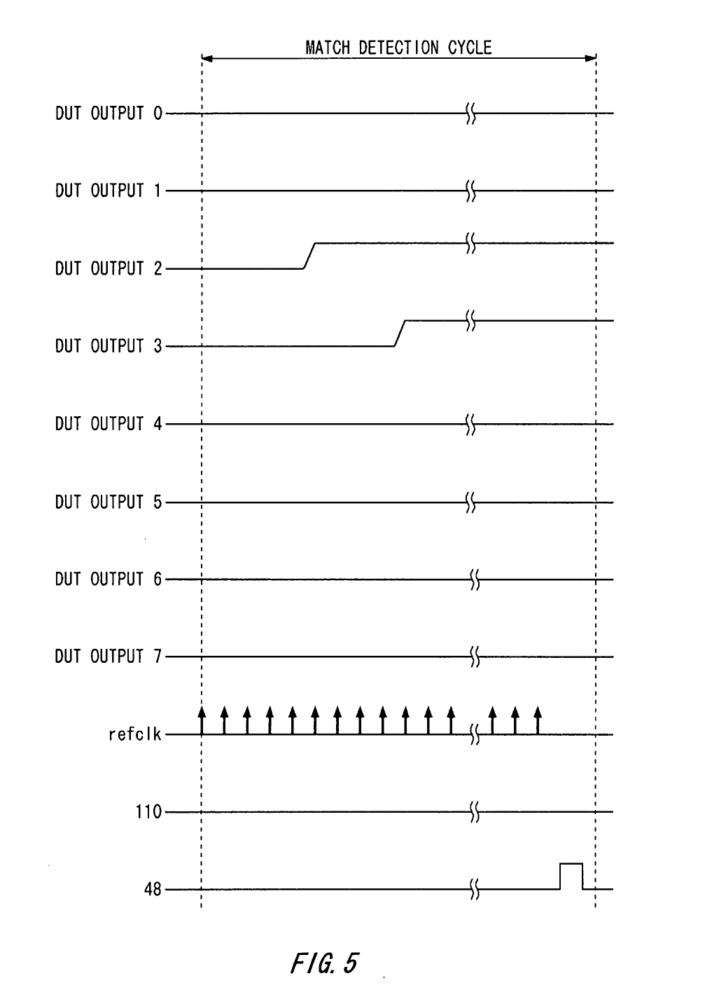

FIG. 5 is a timing chart illustrating, as one example, the signals which are output from the logical AND circuit 110 and no match control section 48 when no match is detected within the match detection request cycle. In the present embodiment, the test apparatus 100 performs match detection on the signals output from the output pins 0-7 of the semiconductor device 300.

In this case, no match is detected for one or more of the output signals. Therefore, the logical AND circuit 110 outputs a signal indicating an L logic. Meanwhile, in accordance with the timing of the reference strobe signal within the cycle, the no match control section 48 outputs the no match signal.

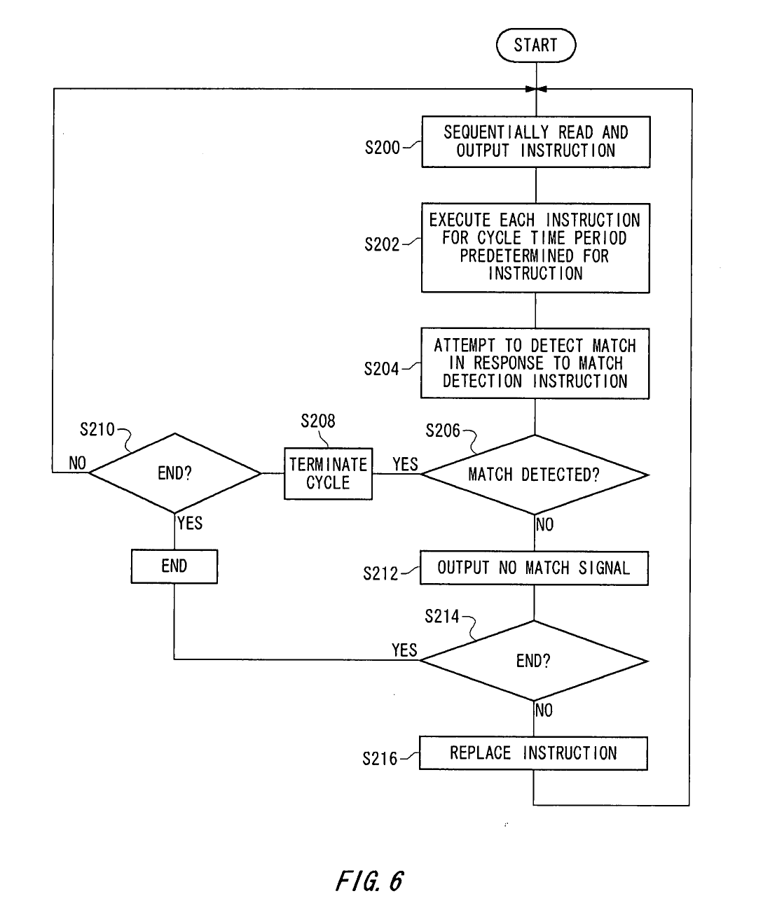

FIG. 6 is a flow chart illustrating one example of a test method relating to an embodiment of the present invention. According to the test method, a semiconductor device is tested in the same method as the method used by the test apparatus 100 described with reference to FIGS. 1 to 5.

To begin with, in a pattern generating step S200, waveform information, which is to be used to test a semiconductor device, is sequentially read and output. In the following waveform generating step S202, a waveform is generated based on the waveform information, and input into the semiconductor device.

In the subsequent match detecting step S204, it is detected whether the output signal from the semiconductor device matches an expected value pattern in response to a signal indicating a match detection request cycle. In the match detecting step S204, a sufficiently long time period is set to the match detection request cycle as described with reference to FIGS. 1 to 5, and match detection is performed at a plurality of timings within the match detection request cycle.

When match is successfully detected, the match detection request cycle is terminated prior to the original end timing of the match detection request cycle in an interrupt step S208. After this, it is judged whether the semiconductor device has been tested in terms of all the aspects (S210). When judged positively, the test of the semiconductor device ends. When judged negatively, the process starting from the step S200 is repeated.

When no match is detected within the match detection request cycle in the step S204, a no match signal is output so that an appropriate process corresponding to the no match signal is performed as described with reference to FIG. 2 (S212).

After this, it is judged whether the semiconductor device has been tested in terms of all the aspects (step S214). When judged positively, the test of the semiconductor device ends. When judged negatively, the waveform information having been stored on the flip-flop 24 is replaced (step S216), and the process starting from the step S200 is repeated.

As clearly indicated by the foregoing description, an embodiment of the present invention can improve the efficiency of a test to be performed on a semiconductor device.

While one aspect of the present invention has been described through some embodiments of the present invention, the technical scope of the invention is not limited to the above described embodiments. It is apparent to persons skilled in the ail that various alternations and improvements can be added to the above-described embodiments. It is also apparent from the scope of the claims that the embodiments added with such alternations or improvements can be included in the technical scope of the invention.

What is claimed is:

1. A test apparatus for testing a semiconductor device, comprising:
a pattern generating section that sequentially reads and outputs waveform information to be used for testing the semiconductor device, the waveform information being made up by a plurality of pieces of data;
a waveform generating section that generates a waveform based on the waveform information which is sequentially output from the pattern generating section;
a match detecting section that detects, in response to a signal indicating a match detection request cycle output from the pattern generating section, whether an output signal output from the semiconductor device matches an expected value pattern output from the pattern generating section; and
an interrupt section that, when the match detecting section detects that the output signal matches the expected value pattern terminates the match detection request cycle and causes the pattern generating section to output next waveform information.

2. The test apparatus as set forth in claim 1, wherein
the pattern generating section includes:
a period generating section that outputs a period signal having a predetermined cycle time; and
a plurality of flip-flops cascaded that (i) sequentially store thereon the plurality of pieces of data making up the waveform information which are to be sequentially output to the waveform generating section, and (ii) output the sequentially stored plurality of pieces of data to the waveform generating section in synchronization with the period signal, and
when the match detecting section detects that the output signal matches the expected value pattern, the interrupt section causes the period generating section to output a next period signal prior to an original end timing of the match detection request cycle.

3. The test apparatus as set forth in claim 2, wherein
the plurality of flip-flops sequentially store thereon in advance the plurality of pieces of data making up the waveform information which are to be output to the waveform generating section when the match detecting section detects that the output signal matches the expected value pattern, and the number of the plurality of pieces of data is determined in accordance with the number of stages of the plurality of flip-flops.

4. The test apparatus as set forth in claim 3, wherein
the interrupt section includes:
a no match control section that, when the match detecting section detects no match between the output signal and the expected value pattern within the match detection request cycle, causes the period generating section to output a period signal having pulses the number of which is determined in accordance with the number of the stages of the plurality of flip-flops, prior to the original end timing of the match detection request cycle; and
a period holding section that suspends the output of the plurality of pieces of data making up the waveform information from the plurality of flip-flops to the waveform generating section for an interval during which the no match control section causes the period generating section to output the period signal having the pulses the number of which is determined in accordance with the number of the stages of the plurality of flip-flops.

5. The test apparatus as set forth in claim 4, wherein
the interrupt section further includes:
a match control section that, when the match detecting section detects that the output signal matches the expected value pattern, outputs a match signal having substantially the same pulse width as the period signal, and
the period generating section outputs, as the period signal, a signal obtained by performing a logic addition on the period signal having the predetermined cycle time and the match signal.

6. The test apparatus as set forth in claim 5, wherein
the period generating section includes:
a period counter that receives period data indicating a cycle time associated with the waveform information in response to an enable signal supplied thereto, measures a time period by counting a reference clock supplied thereto, and outputs the period signal when the measured time period becomes equal to the cycle time indicated by the period data; and
a logical OR circuit that outputs, as the period signal, a signal obtained by performing a logical addition on the period signal output from the period counter and the match signal, and inputs the period signal into the period counter as the enable signal.

7. The test apparatus as set forth in claim 6, wherein
the no match control section outputs a no match signal to the period holding section when the match detecting section detects no match between the output signal and the expected value pattern within the match detection request cycle, and
when receiving the no match signal, the period holding section (i) prohibits the period counter from counting the reference clock for the interval during which the period generating section outputs the period signal having the pulses the number of which is determined in accordance with the number of the stages of the plurality of flip-flops, and (ii) outputs the match signal to the logical OR circuit after the period generating section completes outputting the period signal having the pulses the number of which is determined in accordance with the number of the stages of the plurality of flip-flops.

8. The test apparatus as set forth in claim 1, wherein the waveform generating section includes:
a strobe generating section that generates a plurality of strobe signals having different phases from each other within the match detection request cycle; and
a timing comparator that detects a value of the output signal at each of a plurality of timings defined by the plurality of strobe signals, and
the match detecting section detects whether the value of the output signal detected by the timing comparator matches the expected value pattern supplied thereto.

9. The test apparatus as set forth in claim 8, wherein
the strobe generating section does not generate the plurality of strobe signals after a predetermined end timing within the match detection request cycle.

10. The test apparatus as set forth in claim 9, wherein
the strobe generating section does not generate the plurality of strobe signals before a predetermined start timing within the match detection request cycle.

11. A test method for testing a semiconductor device, comprising:
sequentially reading and outputting waveform information to be used for testing die semiconductor device, the waveform information being made up by a plurality of pieces of data;
generating a waveform based on the waveform information which is sequentially output in the sequential reading and outputting;
detecting, in response to a signal indicating a match detection request cycle output in the sequential reading and outputting, whether an output signal output from the semiconductor device matches and expected value pattern; and
terminating the match detection request cycle and outputting next waveform information in the sequential reading and outputting, when the output signal matches the expected value pattern.
